(19) United States
(12) Patent Application Publication
(10) Pub. No.: US 2016/0346718 A1
(43) Pub. Date: Dec. 1, 2016

(54) DEVICES AND METHODS FOR SEPARATING EMULSIONS AND FILTERING ORGANIC MATERIALS FROM AQUEOUS SAMPLES

(71) Applicant: YULIA HOLENBERG, EL-ROM (IL)

(72) Inventor: YULIA HOLENBERG, EL-ROM (IL)

(21) Appl. No.: 14/720,908

(22) Filed: May 25, 2015

(51) Int. Cl. B01D 35/26; B01D 39/16; B01D 35/30

(52) U.S. Cl. CPC B01D 35/26; B01D 35/30; B01D 39/1607

(57) ABSTRACT

The invention discloses devices and methods for allowing facile separation of components of emulsions as well as filtering of contaminants from liquid samples. Plastically-compressible materials are selectively compressed to create gradients of pores having different average diameters. Flowing samples through such structures allows for separation of materials and the formation of micro- and macro-particles which can be easily collected after treatment. Oil-water emulsions are quickly and efficiently resolved by various embodiments of the present invention.

### FIELD AND BACKGROUND OF THE INVENTION

The present invention, in some embodiments thereof, relates to methods and devices for facile separation of water-oil and similar emulsions. The instant invention, in some embodiments, allows for a gradient of pores in polyurethane or similar materials to aid in removing oil from water and collecting the oil free of water.

Fracking has made for a revolution in hydrocarbon production in the US. The United States currently is the number one gas and oil producer in the world. Fracking requires injection of water and/or other fluids to prepare for release of underground gas/oil reserves. As a result of the process, water/oil emulsions are typical. Such emulsions are found in other applications such as shipping. Separating oil and retrieving clean water is one of the challenges faced by oil firms as well as others.

Whereas organic and aqueous phases generally separate, in emulsions and similar mixtures, the phases remained mixed together and are in need of active separation. The same may be true for removal of wastes from water and organic solvents.

Requirements for separating wastes and clarifying emulsions include speed of separation, robustness of filtering system, energy required to push a solution through a filtration device, success of separation, and cost of technology.

U.S. Pat. No. 7,364,663 to Larson teaches a filter system for receiving an oil-in-water emulsion contaminated with an emulsified contaminant oil, and separating the emulsified contaminant oil from the oil-in-water emulsion includes a filter media for receiving the oil-in-water emulsion and emulsified contaminant oil, having an inner filter element formed from a 95 percent single pass efficiency 48 micron (5 micron nominal) filtering material of needle punch polypropylene felt, an outer filter element formed from a 95 percent single pass efficiency 19 micron absolute filtering material of a polypropylene microfiber material and a porous spun bond polypropylene sandwiching the outer filter media. The filter element de-emulsifies the emulsified contaminant oil from the oil-in-water emulsion into the contaminant oil and the oil-in-water emulsion, separates the de-emulsified contaminant oil from the oil-in-water emulsion, coalesces the separated contaminant oil and passes both the coalesced de-emulsified contaminant oil and the oil-in-water emulsion. A first tank supports the filter element and is further configured to hold a quantity of the separated coalesced contaminant oil and the oil-in-water emulsion. The first tank has an overflow passing to a second tank. The second tank has an oil separation assembly for removing the oil-in-water emulsion from the contaminant oil and passing the oil-in-water emulsion therefrom.

International Patent Application Number PCT/KR1996/000193 to Shon describes an apparatus for separating oil from waste water containing oil emulsion and includes a waste water reservoir for holding the waste water containing oil emulsion, waste water treating arrangement for treating the waste water supplied from the waste water reservoir, oil float waiting reservoir, oil collecting reservoir, chemical reactor tank, and chemical tank. The oil float waiting reservoir is to hold the treated water delivered from the waste water treating arrangement for a given time so as to make the oil part in the treated water float separated from the water part falling down by the force of gravity to the bottom. The waste water treating arrangement includes a treatment tank for holding the waste water to treat, catalyst supply device for supplying a catalyst to the waste water in the treatment tank to enhance the electrical conductivity of the waste water, and circulation piping provided with a magneto fluid dynamic device and circulation pump to circulate the waste water with enhanced electrical conductivity in order to destroy the stability of the oil droplets dispersed in the waste water.

U.S. Pat. No. 6,787,027 issued to Shell Oil Company teaches a process for separating an emulsion of a bituminous oil and water into a liquid water phase and a liquid bituminous oil phase, wherein the following steps are performed: (a) raising the temperature of the bituminous oil/water emulsion having a temperature of below 100° C. to a temperature of above 140° C., and (b) performing a phase separation wherein a water phase and oil phase is obtained, wherein the heating of the emulsion in step (a) is effected by first mixing part of oil phase obtained in step (b) having a temperature of above 140° C. with the bituminous oil/water emulsion and subsequently raising the temperature of the resulting mixture to a temperature of above 140° C. by making use of indirect heat exchange means.

U.S. Pat. No. 4,591,441 to Sakai describes an oil separation method and apparatus for separation by coarse particulation which includes the steps of forming a coarse particulating element with an oil water separation layer which includes forming a water insoluble hydrogel which has an oil resisting and oil repelling function as well as water permeating and absorbing function on the surface of a porous material and/or the surface of a fluid passage to be contacted with oil holding water and alternately passing the oil holding water through the surface of the element to perform coarse particulation separation of oil at the surface of the element. The oil water separation device corresponding thereto includes at least one coarse particulating element forming a layer which include a non-water soluble hydrogel layer with an oil water separation function and having both an oil resisting and oil repelling function as well as a water permeating and water absorbing function and a mechanism for passing oil holding water alternately from one side or the other of the element.

### SUMMARY OF THE INVENTION

It is therefore a purpose of the present invention, in some embodiments, to describe methods and devices for providing filtering and separating of oil from water.

The invention includes a device for clarifying an emulsion including the following: at least one continuous piece of a compressible porous material adapted to have an emulsion passed through it in a predetermined direction and further adapted to being composed of a first gradient of pores with decreasing pore size from a first side of the material until a middle region of the material and a second gradient of pores of increasing pore size from the middle region of the material to a second side opposite of the first side of the material; and, a source of energy adapted to drive an emulsion through the material from the first side through the second side.

In one aspect of the device, the material is realized as polyurethane, glass fiber, cellulose fiber synthetic fibers including but not limited to polypropylene, fluoropolymer fine fiber or fine fibers produced by electro-spinning, foamed elastic materials including but not limited to propylene or polyester-based elastic foams, foamed methylene diphenyl diisocyanate, and foamed polysterol.

In another aspect of the device, first gradient of pores includes pores of sizes from 500 microns to 50 microns.

In another aspect of the device, the second gradient of pores includes pores of sizes from 50 microns to 500 microns.

In another aspect of the device, the porous material is realized as a plurality of porous materials.

In another aspect of the device, the emulsion is realized as a mixture of oil and water.

In another aspect of the device, the emulsion is realized as oil in water, organic materials in water, mixtures of organic materials, organic materials in air, gas mixtures, aqueous mixtures.

In another aspect of the device, the source of energy is applied to a pump adapted to drive the emulsion in a single direction and with progressively increasing liquid pressure.

In another aspect of the device, there is additionally a carrier liquid adapted to receive separated the first component and the second component of the emulsion after passage of the emulsion through the pores closest to the second side.

The invention includes a method for clarifying an emulsion, including: providing a compressible porous material in a generally toroidal shape; applying even mechanical pressure to the compressible porous material, so as to create within the material a first gradient of pores with decreasing pore size from a first side of the porous material until a middle region of the porous material and a second gradient of pores of increasing pore size from the middle region of the porous material to a second side opposite of the first side of the porous material; passing an emulsion through the pores of the first side, passing the emulsion through pores of the middle region; passing the emulsion through the pores of the second side; allowing a first component and a second component of the emulsion to separate into a carrier liquid adapted to flow beyond the second side; isolating the first component; and, isolating the second component.

In one aspect of the method, the applying is performed by mechanical deformation.

In another aspect of the method, there is an addition step of fixing the material so as to retain post-applying pore sizes.

In another aspect of the method, the pores range in size from 50 microns to 500 microns.

In another aspect of the method, the material has a thickness of 1 millimeter to 1 meter.

In another aspect of the method, the material is realized as portion of a filtration unit.

In another aspect of the method, the passing is performed by a liquid pump.

The invention includes a device for filtering a liquid from a contaminant, including the following: a continuous piece of a compressible porous material adapted to have a liquid pushed through it in a singular direction and further adapted to being composed of a gradient of pore sizes from a first side of the material to a second side of the second material, wherein pores decrease in size from the first side to the second side; a liquid including at least one contaminant, wherein the pores closest to the second side are adapted to retain the at least one contaminant and are further adapted not to retain the liquid; a source of energy adapted to drive the liquid source through pores of the material from the first side to the second side; and, an exit zone adapted to receive the liquid significantly devoid of the at least one contaminant.

In one aspect of the device, the device is realized as part of an automotive air filter.

In another aspect of the device, the pores range in size from 20 microns to 500 microns in diameter.

In yet another aspect of the device, the liquid is realized as water and the contaminant is selected from oil, grease, fuel, or organic material.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. It is noted that similar elements in various drawings may have the same number, advanced by the appropriate multiple of 100.

In the drawings:

FIG. 1 shows a prior art view of a series of micrographs of polyurethane;

FIG. 2 shows a schematic view of an embodiment of the instant invention;

FIG. 3 shows an additional view of the same embodiment;

FIG. 4 shows a flowchart for an alternative embodiment of the invention;

FIGS. 5A-5D show schematic views of elements related to the alternative embodiment;

FIGS. 6 & 7 show schematic views relating to a further embodiment of the invention;

FIGS. 8 & 9 show schematic views of donut-shaped polyurethane elements used in construction of an emulsion separation device;

FIG. 10 shows a schematic view of an alternative arrangement of elements prior to compressing the elements into a final separation unit;

FIG. 11 shows a schematic view of a separation unit in a plastic housing for use in separation of emulsions; and,

FIG. 12 shows a graph relating flow rate and quality of emulsion separation.

### DESCRIPTION OF SPECIFIC EMBODIMENTS OF THE INVENTION

The present invention, in some embodiments thereof, relates to methods and devices for facile separation of oil-water emulsions as well as removal of contaminants from liquid systems.

For purposes of better understanding, some embodiments of the present invention are illustrated in the figures of the drawings. Without being bound by any theory, the following discussion is offered. It is noted that polyurethane and other deformable materials can be compressed via mechanical or other means. By selecting the shape of a foam-like material properly and applying pressure to part but not all of the material, regions with smaller pores may be created aside regions of larger “standard” pores. As described in the embodiments and examples below, polyurethane and similarly deformable materials may be mechanically compressed to create gradients of pores in which areas of larger pores abut regions of smaller pores generated by the compression. The behavior of the gradients is to allow for separation of materials and their further self-association to form macro-drops or particles which trivially separate from a host water phase. In some embodiments of the instant invention, the foam may have a hydrophilic or hydrophobic quality. Such a quality may be inherent in the foam itself or may be a result of chemical or other treatment of the foam-based material prior to its use. Hydrophilic and hydrophobic qualities allow for additional screening/separation capabilities for various applications associated with said embodiments.

### First Embodiment

The invention includes a device for clarifying an emulsion including the following: at least one continuous piece of a compressible porous material adapted to have an emulsion passed through it in a predetermined direction and further adapted to being composed of a first gradient of pores with decreasing pore size from a first side of the material until a middle region of the material and a second gradient of pores of increasing pore size from the middle region of the material to a second side opposite of the first side of the material; and, a source of energy adapted to drive an emulsion through the material from the first side through the second side.

In one aspect of the device, the material is realized as polyurethane, glass fiber, cellulose fiber synthetic fibers including but not limited to polypropylene, fluoropolymer fine fiber or fine fibers produced by electro-spinning, foamed elastic materials including but not limited to propylene or polyester-based elastic foams, foamed methylene diphenyl diisocyanate, and foamed polysterol. In another aspect of the device, first gradient of pores includes pores of sizes from 500 microns to 50 microns. In another aspect of the device, the second gradient of pores includes pores of sizes from 50 microns to 500 microns. In another aspect of the device, the porous material is realized as a plurality of porous materials. In another aspect of the device, the emulsion is realized as a mixture of oil and water. In another aspect of the device, the emulsion is realized as oil in water, organic materials in water, mixtures of organic materials, organic materials in air, gas mixtures, aqueous mixtures. In another aspect of the device, the source of energy is applied to a pump adapted to drive the emulsion in a single direction and with progressively increasing liquid pressure.

In another aspect of the device, there is additionally a carrier liquid adapted to receive separated the first component and the second component of the emulsion after passage of the emulsion through the pores closest to the second side.

It is understood that the porous material may be of any size, though practically it is usually measured in centimeter to meter dimensions while pores are generally between 1 and 1000 micron (μm), though larger or smaller pores are possible. Compressibility as it relates to the instant invention may generally relate to a plastic material that is amenable to physical compression by mechanical, heat, or chemical means, wherein the product has regions with smaller pores than normally found in the plastic material prior to any compression. Typical polyurethane for the instant invention has pores of sizes ranging from 500 to 800 microns; compression may reduce average pore size in a compressed region to 20 microns or less. One may selectively compress so as to create regions of smaller pores and gradients of pores from large to small and small to large within areas of the compressible material.

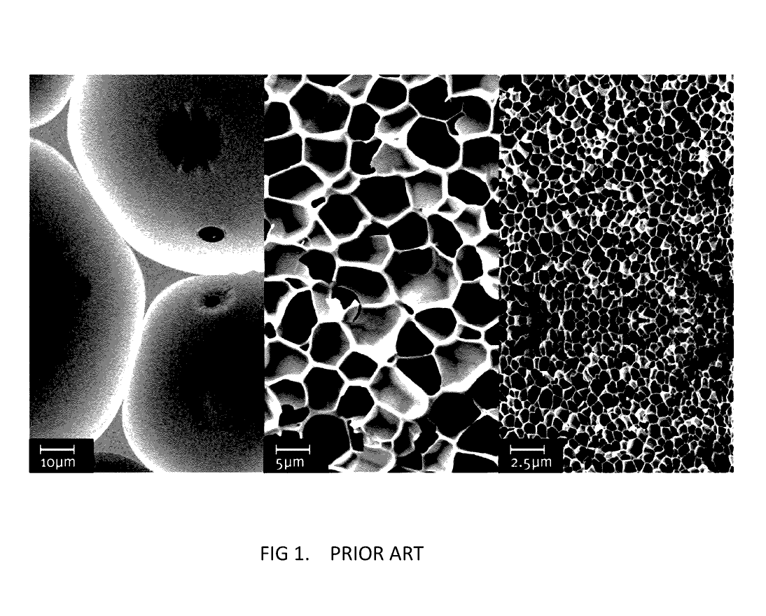

Attention is turned to FIG. 1 which shows a prior art example of pores of polyurethane. In the figure there are three unrelated samples of polyurethane of differing pore sizes, as shown by the size bars. It is noted that each polyurethane sample shown has a single average pore size throughout its mass. It is noted that average pore size is only a representative figure and actual pore sizes may vary significantly from a given average. In discussing average pore size, it is understood that there may a range of actual pore dimensions; average values are discussed and presented so as to aid in the understanding of the instant invention.

Unlike the prior art example from FIG. 1, in the instant invention, in some embodiments thereof, a single piece of polyurethane or similarly compressible material will have predetermined regions with smaller pore sizes. The net effect is to create an internal gradient of pore sizes that may range from large (˜500 microns diameter) to small (˜20 microns diameter). The pore gradients created within the polyurethane or similar material allows or facile separation of emulsions as well as removal of contaminations from aqueous solutions.

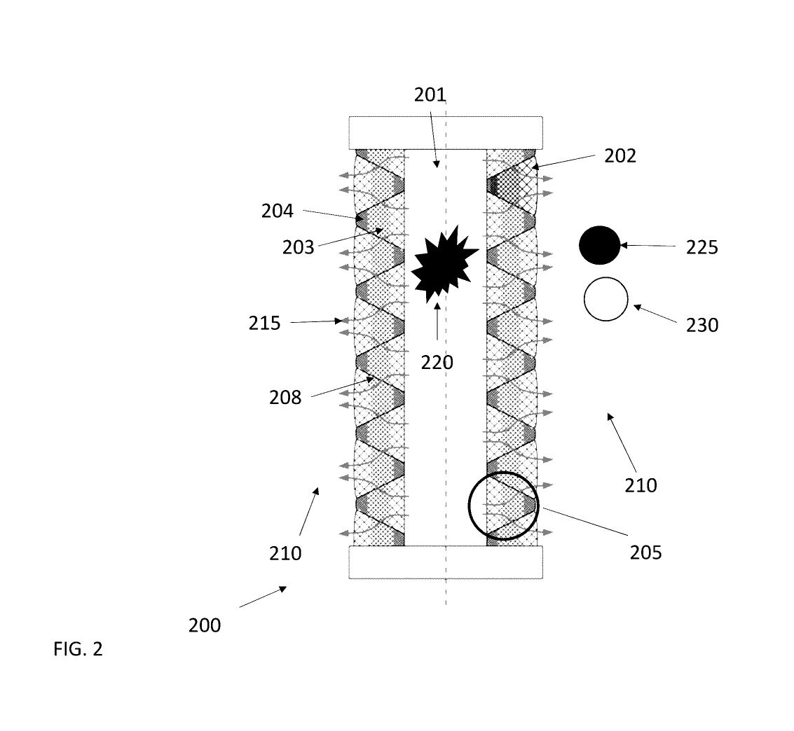

Attention is turned to FIG. 2. A water-oil emulsion separation device 200 includes a plurality of pore gradient regions 205 that include large pores 202 of approximately 500 microns diameter, medium-sized pores 203 of 100 microns aver pore diameter and still further regions of small pores 204 with average pore diameter of approximately 20 microns. The gradient regions 205 may be made separately and joined or may be made in-situ together. The device 200 includes an emulsion entry space 201 adapted to receive a water-oil emulsion or other type of emulsion whose components may not readily separate. Electrical power is provided to a pump (not shown in figure) that drives an emulsion 220 from the entry space 201 through the plurality of gradient regions 205 and to a region outside 210 of the device 200. Arrows 215 show the passage of separated oil 225 and water 230 from the inner side 201 of the device to the outer side 210 of the device. An emulsion 220 is pushed from the emulsion entry space 201 and into the region of large pores 202. The emulsion 220 passes through the same. The emulsion 220 then encounters the region of the pore gradient that includes medium-sized pores 203 and the oil begins to separate from the water due to the size of the medium pores as well as possibly chemical aspects of the pore material. Additional pressure from the pump causes the oil and water to bypass small pores 204 which are too small for the developing oil particles which coalesce and leave the device 200 to the outer region as clarified oil 225 particles. Oil 225 and water 230 are the final products that leave the device 200 after separation. An optional carrier liquid (not shown) may be found in the outside 210 region, in which case oil 225 droplets rise to the top of the carrier liquid, while water 230 joins the carrier liquid. Separated oil 225 may then be separated from the carrier liquid and re-used or discarded.

Emulsion 220 cannot enter the small pores 204 facing the emulsion entry space 201 and are forced, under pressure from the pump, to enter the regions of large pores 202 on their way out of the separation device 200. In some embodiments plates 208 may be used to help direct the flow of liquid between separate gradient regions 205. Such plates 208 are generally made out of metal.

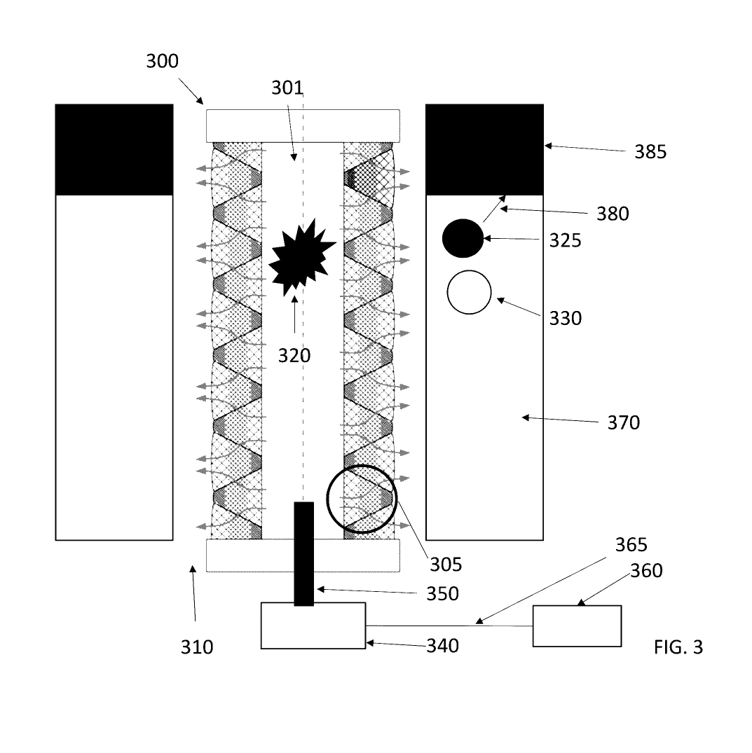

Attention is turned to FIG. 3. A water-oil emulsion separation device 300 includes a pump 340 which may be driven by electricity or gasoline or other energy source. The pump 340 includes an inlet hose 350 for delivery of emulsion 320 into the emulsion entry space 301. The pump 340 is under control of a computer controller 360 that is in electrical communication with the pump 340 either with an electrical wire 365 or wirelessly (not shown). A carrier liquid 370 is run continuously outside of the device 300 and is adapted to receive oil 325 and water 330 clarified from the emulsion 320. Water 330 joins the carrier liquid 370 while oil 325 rises 380 to form an oil layer 385. Pressure applied by the pump 340 on the emulsion 320 to force the emulsion 320 through the pore gradient regions 305 is selected so as to effect as complete a separation of components as possible.

### Second Embodiment

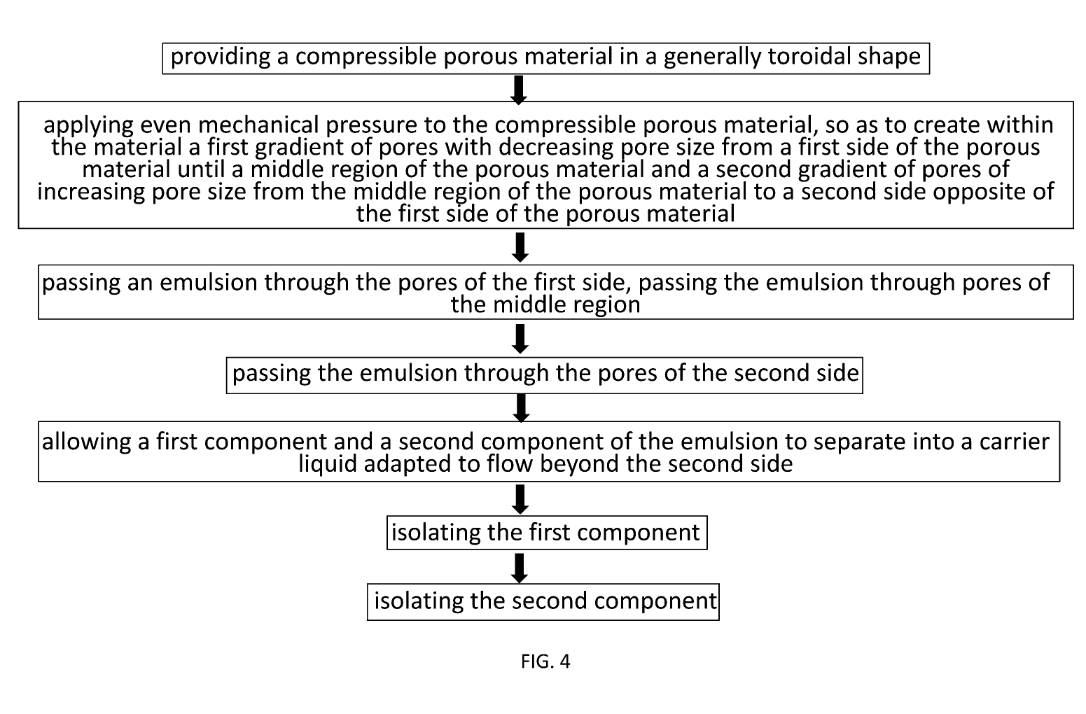

Attention is turned to FIG. 4 which shows a flowchart for an embodiment of the instant invention. The invention includes a method for clarifying an emulsion, including: providing a compressible porous material in a generally toroidal shape; applying even mechanical pressure to the compressible porous material, so as to create within the material a first gradient of pores with decreasing pore size from a first side of the porous material until a middle region of the porous material and a second gradient of pores of increasing pore size from the middle region of the porous material to a second side opposite of the first side of the porous material; passing an emulsion through the pores of the first side, passing the emulsion through pores of the middle region; passing the emulsion through the pores of the second side; allowing a first component and a second component of the emulsion to separate into a carrier liquid adapted to flow beyond the second side; isolating the first component; and, isolating the second component.

In one aspect of the method, the applying is performed by mechanical deformation. In another aspect of the method, there is an addition step of fixing the material so as to retain post-applying pore sizes. In another aspect of the method, the pores range in size from 50 microns to 500 microns. In another aspect of the method, the material has a thickness of 1 millimeter to 1 meter. In another aspect of the method, the material is realized as portion of a filtration unit. In another aspect of the method, the passing is performed by a liquid pump.

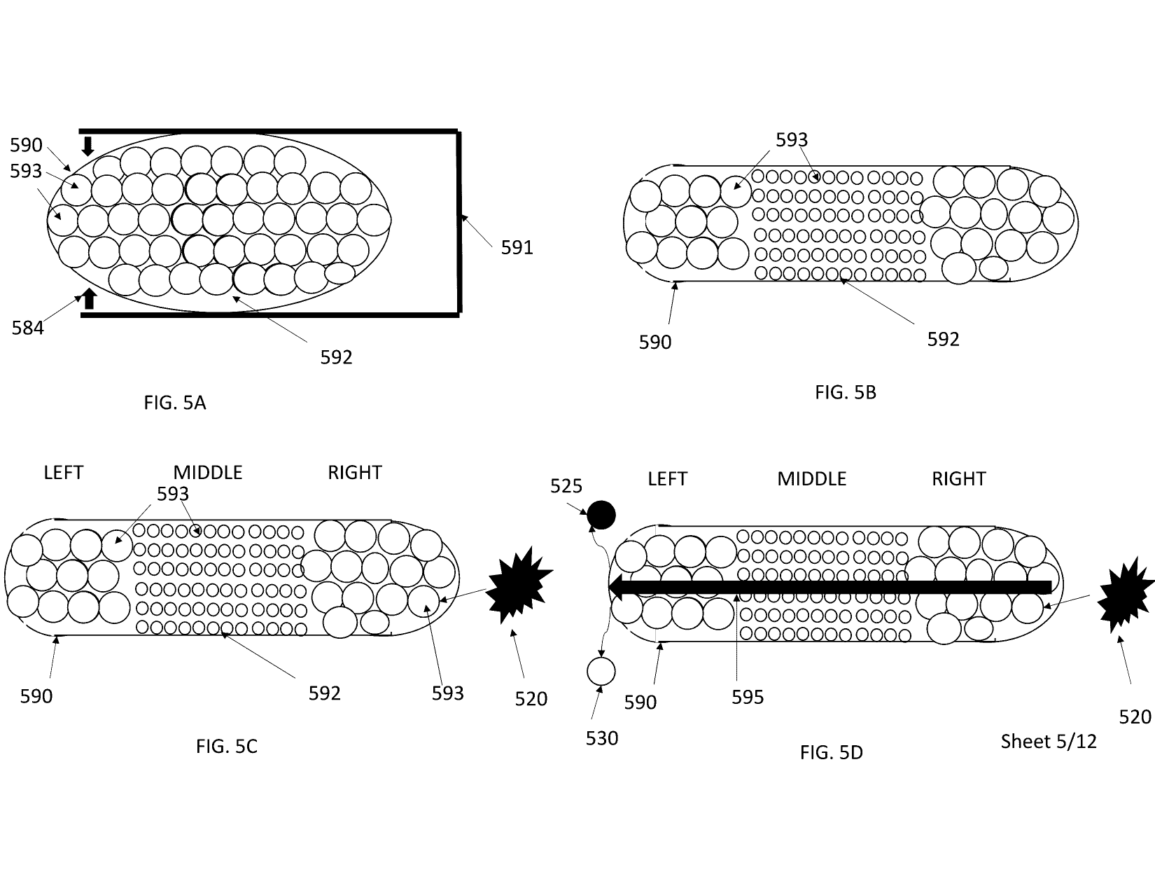

The preference for the toroidal shape may be understood in FIG. 5A. FIG. 5A shows a schematic view of a porous piece of polyurethane 590 having a generally toroidal shape and composed of a plurality of pores 593. A press 591 is placed around a middle region 592 of the polyurethane and pressure 584 applied by the press 591 is used to compress a middle region 592 of the polyurethane 590. FIG. 5B shows the results of application of pressure to the middle region 592 of the polyurethane 590: the polyurethane 590 takes on a more rectangular appearance, with the compressed middle region 592 having pores 593 of a significantly smaller diameter. The modified polyurethane 590 may alternatively be “fixed” by chemical, heat, or other means so as to keep the pore 593 diameters fixed (not shown).

Attention is turned to FIG. 5C. An emulsion 520 may be applied to the polyurethane 590 at the right side where large diameter pores 593 allow for passage of the emulsion 520 into the polyurethane 590. In the middle region 592 of the polyurethane 590, the emulsion 520 encounters smaller pores 593 which cause for separation of oil and water into separated micro-particles. The pores may have specific chemical properties beyond mere size in order to encourage emulsion 520 separation and/or sample purification. The separated oil and water continue under pressure to the pores on the left side of the polyurethane 590 where particles aggregate. Water and oil, fully separated, leave the polyurethane 590 where they can be collected separately (not shown).

FIG. 5D summarizes the process: emulsion 520 enters on the right side, passes through a gradient of pores large/small/large from right to middle to left as suggested by the arrow 595. On the left side of the polyurethane 590 product oil 525 and water 530 emerge from the polyurethane 590 where the separated products may be collected separately.

In some embodiments of the instant invention, one may attach or press together polyurethane or the like of different pore diameter in order to make a gradient of pore sizes from initially separate piece of polyurethane, wherein each unique piece has pores of a desired pore diameter.

### Third Embodiment

The invention includes a device for filtering a liquid from a contaminant, including the following: a continuous piece of a compressible porous material adapted to have a liquid pushed through it in a singular direction and further adapted to being composed of a gradient of pore sizes from a first side of the material to a second side of the second material, wherein pores decrease in size from the first side to the second side; a liquid including at least one contaminant, wherein the pores closest to the second side are adapted to retain the at least one contaminant and are further adapted not to retain the liquid; a source of energy adapted to drive the liquid source through pores of the material from the first side to the second side; and, an exit zone adapted to receive the liquid significantly devoid of the at least one contaminant.

In one aspect of the device, the device is realized as part of an automotive air filter. In another aspect of the device, the pores range in size from 20 microns to 500 microns in diameter. In yet another aspect of the device, the liquid is realized as water and the contaminant is selected from oil, grease, fuel, or organic material.

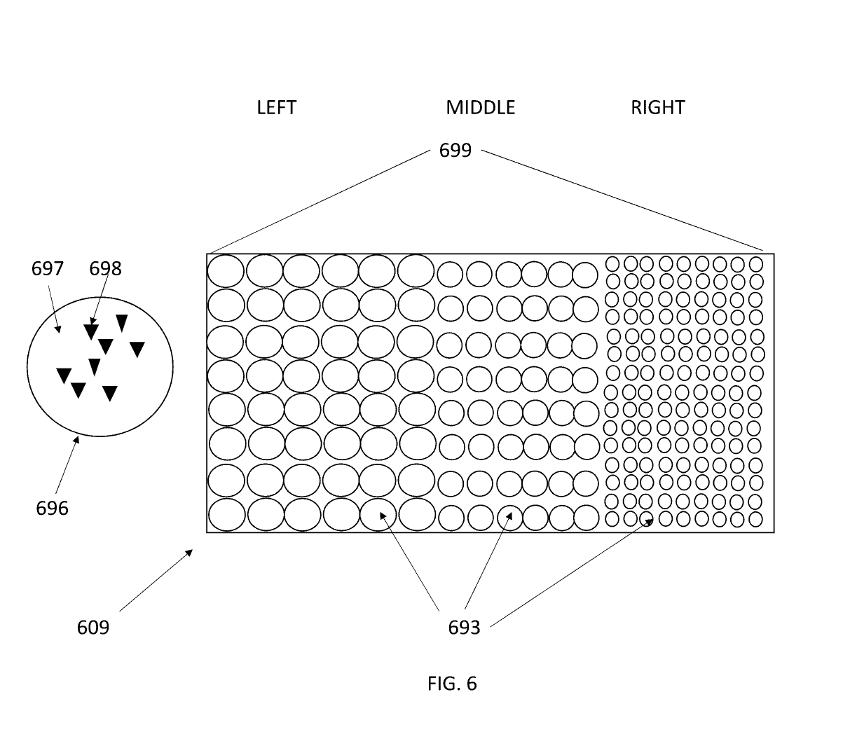

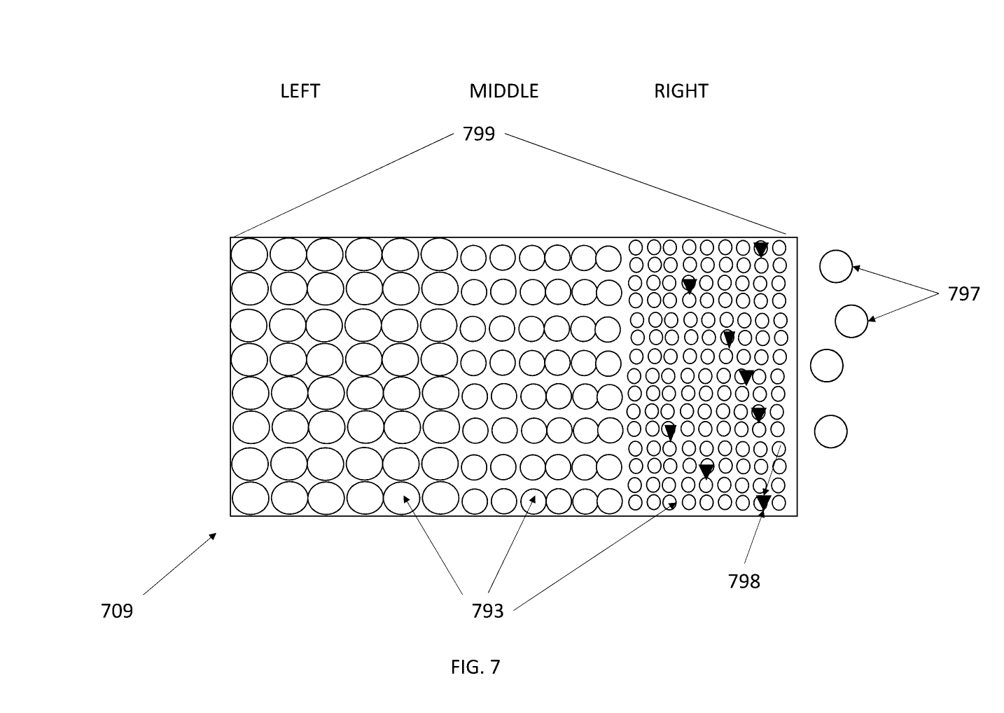

Attention is turned to FIG. 6 which shows a schematic view of the instant embodiment. A filter 609 including a gradient 699 of pores 693 of various sizes is provided. The largest pores 693 are shown on the left side of the filter 609, with medium sized pores 693 in the middle, and smallest pores 693 on the right. A sample 696 includes a liquid 697 that has one or more contaminants 698. The sample 696 is adapted to be driven across the filter generally in a singular direction, from left to right. Attention is turned to FIG. 7. Sample (not shown) has been pushed through the filter 709 and passage through the gradient 799 of pores 793 has led to contaminants 798 being trapped in the smallest diameter pores 793 while liquid 797 passes through and exists the filter 709. Contaminants 798 are left behind in the pores 793 of the filter 709 while clean liquid 797 leaves the filter 709 significantly cleaner. It is understood that a gradient 799 may include only two sets of pores 793 of different sizes (and not three, as shown). Additionally, a sample may be pushed in more than one direction and/or back and forth through the gradient 799.

### Example

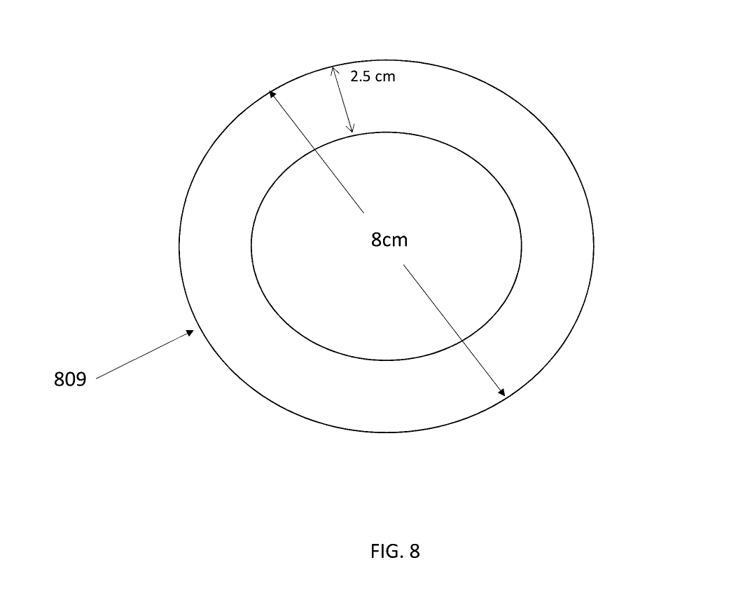

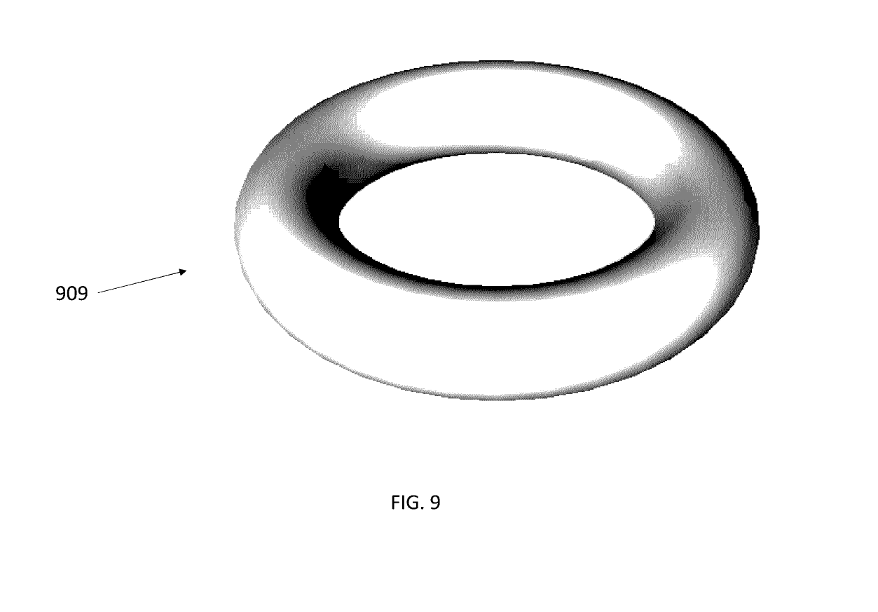

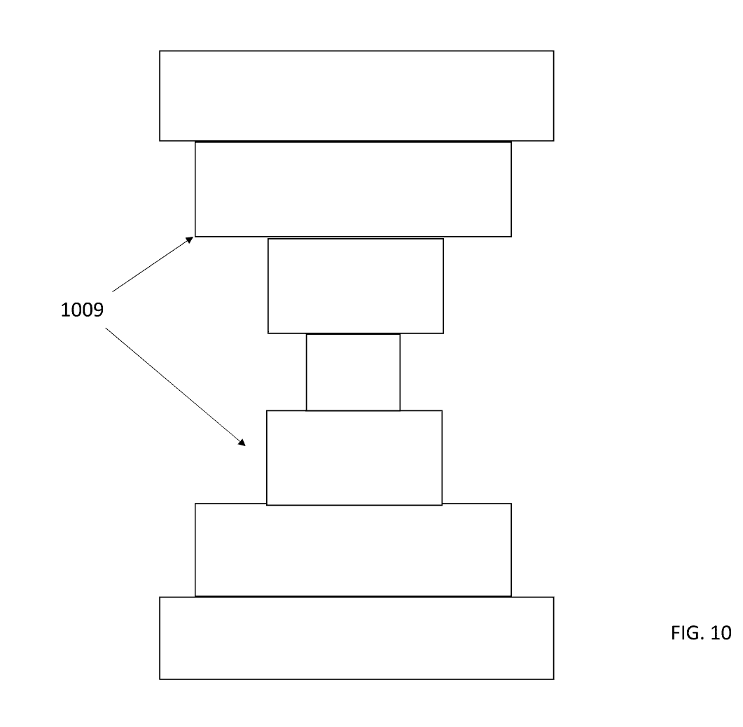

Polyurethane foam of 500 micron diameter pore size was supplied (Polyurethane, Ltd., Haifa, Ill.) as a sheet and was cut to specifications, namely into a plurality of donut-shaped elements with 2.5 centimeter diameter of polyurethane and 8 centimeter total diameter of the “donut”. See FIG. 8 which shows a schematic top view of a representative element 809. FIG. 9 shows an alternative view of the donut-shaped polyurethane element 909. 25 such elements 909 were placed one on top of the other for an approximate height of 62.5 centimeters. The stack was compressed by hand to a final height of approximately 14 centimeters (˜4× compression). The pores at the ends of the compressed element remained 500 microns in diameter, while those in the middle had an average diameter of 40 micron as determined by retention properties. The resulting emulsion separation element has shown filtering capabilities of 20 micron with 95% separation performance. Over-compressing of stack (7×) can cause collapse of pores and lack of proper filtration, separation or clarification. In some embodiments, the elements 909 may be of different diameter and may even be filled in the middle. FIG. 10 shows a typical alternative stack of such elements 1009 prior to compression. Compression again leads to large/small/large gradient of pores from one side to the other as described previously.

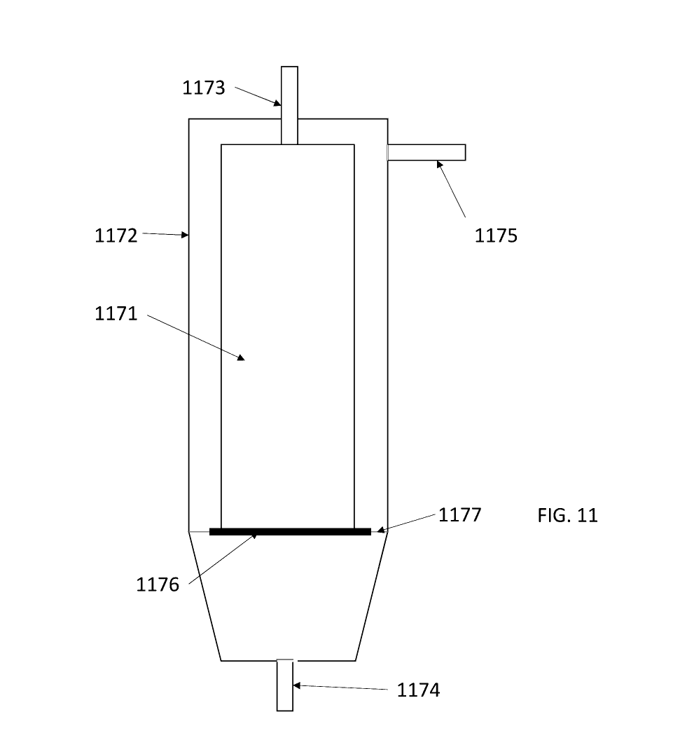

Attention is turned to FIG. 11. The emulsion separation element 1171 at approximately 14 centimeters height was placed in a hard plastic filter case 1172. There was approximately 1 centimeter space between the separation element 1171 and the inner walls of the case 1172. The case 1172 included one inlet 1173 directly into the hollow core of the separation element 1171 and two outlets 1174 & 1175. The fluid inlet 1173 was located on the top of the filter case 1172, and one outlet 1174 leads from a funnel at the bottom of the case 1172, while the other outlet 1175, for a lighter component of an emulsion, is located on the side near the top of the filter case 1172. The separation element 1171 sat on a retention bar 1176 and open spaces 1177 on the side of the retention bar 1176 allowed de-emulsified water to pass to the lower outlet 1174.

The emulsion was applied via the inlet under pressure. Pressure was applied by a pump or other source. Typical initial inlet emulsion pressures were 1.2 bar at the beginning. Constant application rate of sample required increased liquid pressures as the separation element 1171 became progressively more fouled. Final pressures of 3 bar were typical. Using too high of a pressure can lead to pore destruction as identified by release of contaminants otherwise restricted within the pores of the separation element 1171. In this Example, sample was run through the separation element “inside out”, namely from the middle of the filter outwards. One could obviously run the instant invention outside in as well or alternatively.

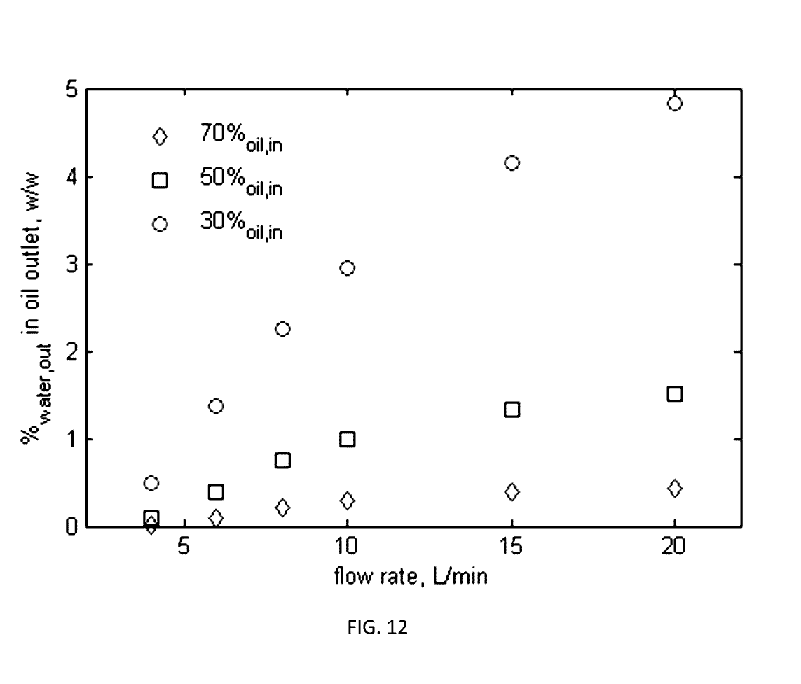

Different emulsions were used in evaluating filter performance. 30%, 50%, and 70% oil in water were analyzed. PPG-1-PEG-9 Lauryl Glycol Ether was used to keep the water and oil in a extended state of emulsion. Varying volumes of emulsion were applied to the filter system at a rate of 3 liters per minute, though different application rates were also applied, as shown in FIG. 12. As seen in the figure, too high of a flow rate leads to a significant decrease in the effectiveness of separation. The recovered water included approximately 100-200 ppm of oil. Changing rate of application had an impact on the amount of oil left in water. Water remaining in oil was approximately 0.5% w/w. Reverse emulsions with water as the minor component were also separated with the separation element 1171. In such cases, PEG-7 Hydrogenated Castor Oil was used to stabilize the emulsions.

Maximum pressure was determined via the release of trapped contamination molecules. The separation element (FIG. 11) 1171 can be regenerated, but due to the low cost of the starting material polyurethane it is not economically advantageous. This separation element 1171 was used under lab settings for several months and had the ability to filter several thousand liters before the filter becomes unusable due to fouling by collected contaminants in the oil. 6,500 liters of emulsions with 20 milligram contaminant per kilogram of emulsion was successfully separated with the separation element herewith described.

In some embodiments, chemicals may be added to an emulsion prior to its application to the filter system.

Applications include emulsions of all kinds including but not limited to water-oil, bilge water, CNC, organic-aqueous systems, colloids suspended in liquids, and contaminated air samples.

As noted above, water recovered from de-emulsification has a residual oil content as high as 200 ppm. In order to reduce the oil concentration to 5 ppm or less, as per the requirements of the Israel Ministry of Health, a filter was created by taking a polyurethane sphere and mechanically compressing it to create a filter with large (500 micron) and small (40) micron pores. Water with oil was directed from large to small pores and the oil was effectively retained in the small pores to reduce the oil content in filtrate water to 5 ppm or less.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. In addition, as used herein the term “about” refers to +/−10%. In addition, when the word “about” is used herein in reference to a number, it should be understood that still another embodiment of the invention includes that number not modified by the presence of the word “about.”

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A device for clarifying an emulsion including the following:
at least one continuous piece of a compressible porous material adapted to have an emulsion passed through it in a predetermined direction and further adapted to being composed of a first gradient of pores with decreasing pore size from a first side of said material until a middle region of said material and a second gradient of pores of increasing pore size from said middle region of said material to a second side opposite of said first side of said material; and,
a source of energy adapted to drive an emulsion through said material from said first side through said second side.

2. The device according to claim 1, wherein said material is realized as polyurethane, glass fiber, cellulose fiber synthetic fibers including but not limited to polypropylene, fluoropolymer fine fiber or fine fibers produced by electro-spinning, foamed elastic materials including but not limited to propylene or polyester-based elastic foams, foamed methylene diphenyl diisocyanate, and foamed polysterol.

3. The device according to claim 1, wherein said first gradient of pores includes pores of sizes from 500 microns to 50 microns.

4. The device according to claim 1, wherein said second gradient of pores includes pores of sizes from 50 microns to 500 microns.

5. The device according to claim 1, wherein said porous material is realized as a plurality of porous materials.

6. The device according to claim 1, wherein said emulsion is realized as a mixture of oil and water.

7. The device according to claim 1, wherein said emulsion is realized as oil in water, organic materials in water, mixtures of organic materials, organic materials in air, gas mixtures, aqueous mixtures.

8. The device according to claim 1, wherein said source of energy is applied to a pump adapted to drive said emulsion in a single direction and with progressively increasing liquid pressure.

9. The device according to claim 1, further including a carrier liquid adapted to receive separated said first component and said second component of said emulsion after passage of said emulsion through said pores closest to said second side.

10. A method for clarifying an emulsion, including:
providing a compressible porous material in a generally toroidal shape;
applying even mechanical pressure to said compressible porous material, so as to create within said material a first gradient of pores with decreasing pore size from a first side of said porous material until a middle region of said porous material and a second gradient of pores of increasing pore size from said middle region of said porous material to a second side opposite of said first side of said porous material;
passing an emulsion through said pores of said first side,
passing said emulsion through pores of said middle region;
passing said emulsion through said pores of said second side;
allowing a first component and a second component of said emulsion to separate into a carrier liquid adapted to flow beyond said second side;
isolating said first component; and,
isolating said second component.

11. The method according to claim 10, wherein said applying is performed by mechanical deformation.

12. The method according to claim 11, further including a step of fixing said material so as to retain post-applying pore sizes.

13. The method according to claim 10, wherein said pores range in size from 50 microns to 500 microns.

14. The method according to claim 10, wherein said material has a thickness of 1 millimeter to 1 meter.

15. The method according to claim 10, wherein said material is realized as portion of a filtration unit.

16. The method according to claim 10, wherein said passing is performed by a liquid pump.

17. A device for filtering a liquid from a contaminant, including the following:
a continuous piece of a compressible porous material adapted to have a liquid pushed through it in a singular direction and further adapted to being composed of a gradient of pore sizes from a first side of said material to a second side of said second material, wherein pores decrease in size from said first side to said second side;
a liquid including at least one contaminant, wherein said pores closest to said second side are adapted to retain said at least one contaminant and are further adapted not to retain said liquid;
a source of energy adapted to drive said liquid source through pores of said material from said first side to said second side; and,
an exit zone adapted to receive said liquid significantly devoid of said at least one contaminant.

18. The device according to claim 17, wherein said device is realized as part of an automotive air filter.

19. The device according to claim 18, wherein said pores range in size from 20 microns to 500 microns in diameter.

20. The device according to claim 18, wherein said liquid is realized as water and said contaminant is selected from oil, grease, fuel, or organic material.
